(19) United States
(12) Patent Application Publication
(10) Pub. No.: US 2019/0351788 A1
(43) Pub. Date: Nov. 21, 2019

(54) VEHICLE SEAT

(71) Applicant: TOYOTA BOSHOKU KABUSHIKI KAISHA, Aichi-ken (JP)

(72) Inventor: Koji KIMURA, Aichi-ken (JP)

(73) Assignee: TOYOTA BOSHOKU KABUSHIKI KAISHA, Aichi-ken (JP)

(21) Appl. No.: 16/415,768

(22) Filed: May 17, 2019

(30) Foreign Application Priority Data
May 21, 2018 (JP) 2018-097116

(51) Int. Cl. B60N 2/10; B60N 2/20; B60N 2/90

(52) U.S. Cl. CPC B60N 2/10; B60N 2/995; B60N 2/20

(57) ABSTRACT

A vehicle seat includes a base frame, a tip-up frame, and a biasing member. The base frame includes a supporting portion provided in a first side wall portion. The tip-up frame includes a supported portion pivotably connected to a second side wall portion. The supported portion is fixed to the first side wall portion while being supported by the supporting portion. The supporting portion is configured to guide the supported portion to bring the tip-up frame to a fixed position in the base frame, and to support the supported portion so as to cause the tip-up frame to be self-standing on the base frame while being disposed at the fixed position.

This nonprovisional application is based on Japanese Patent Application No. 2018-097116 filed on May 21, 2018 with the Japan Patent Office, the entire contents of which are hereby incorporated by reference.

### BACKGROUND

### Field

The present disclosure relates to a vehicle seat and particularly to a vehicle seat installed in a vehicle such as an automobile.

### Description of the Background Art

Conventionally, vehicle seats having various kinds of configurations have been proposed. As one of these vehicle seats, there is a known vehicle seat configured such that a seat cushion can be tipped up. This type of vehicle seat is implemented by providing a tip-up mechanism in a cushion frame formed as a framework of a seat cushion.

Generally, the tip-up mechanism is configured in such a manner that a cushion frame is formed of a base frame fixed to a vehicle and a tip-up frame pivotably installed in the base frame, and also that a biasing member for biasing the tip-up frame in the tipped-up direction toward the seat back is provided between the tip-up frame and the base frame.

For example, Japanese Patent Laying-Open No. 2005-74101 discloses a vehicle seat including a tip-up mechanism having the above-described configuration. The vehicle seat is provided with a pair of right and left brackets protruding upward from a pair of respective side wall portions that are located on the right and left sides of a base frame. A tip-up frame is pivotably attached to each of the brackets.

### SUMMARY

However, the tip-up frame is generally formed as a heavy load. Thus, the operation of pivotably installing a tip-up frame in a base frame is considerably troublesome due to a positioning operation and a fixing operation, and therefore, needs to be simplified in order to improve productivity.

As disclosed in the above-mentioned document, in the configuration in which a pair of right and left brackets are provided so as to protrude upward from a pair of respective side wall portions of the base frame and a tip-up frame is pivotably attached to the pair of brackets, the rotation axis of the tip-up frame does not cross the pair of side wall portions of the base frame. This allows access to a hinge portion from outside in the seat width direction during installation. Thus, this installation can be relatively readily performed. Also in such a case, however, since the tip-up frame is still a considerably heavy load, it is hard to say that the installation operation can be sufficiently readily performed.

On the other hand, in the configuration in which the rotation axis of the tip-up frame crosses the pair of side wall portions of the base frame, for example, in order to reduce the thickness of the cushion frame in the seat up-down direction, the hinge portion cannot be accessed from outside in the seat width direction due to physical blockage by the base frame during installation. Thus, particularly the installation operation becomes extremely difficult.

Therefore, an object of the present disclosure is to simplify installation of a tip-up frame in a base frame in a vehicle seat including a tip-up mechanism.

A vehicle seat according to an aspect of the present disclosure includes: a cushion frame formed as a framework of a seat cushion; and a seat back provided at a rear end portion of the seat cushion. The cushion frame includes a base frame, a tip-up frame supported by the base frame so as to be pivotable about a rotation axis extending in a seat width direction, and a biasing member configured to bias the tip-up frame toward the seat back in a direction in which the tip-up frame pivots. The base frame includes a pair of first side wall portions that are located to face each other in the seat width direction, and a pair of supporting portions that are located to face each other in the seat width direction, each of the paired supporting portions being provided in a corresponding one of the paired first side wall portions. The tip-up frame includes a pair of second side wall portions that are located to face each other in the seat width direction, and a pair of supported portions that are located to face each other in the seat width direction, each of the paired supported portions being pivotably connected to a corresponding one of the paired second side wall portions. Each of the paired supported portions is fixed to a corresponding one of the paired first side wall portions while being supported by a corresponding one of the paired supporting portions. Each of the paired supporting portions is capable of guiding a corresponding one of the paired supported portions in a direction orthogonal to the seat width direction to bring the tip-up frame to a fixed position in the base frame, and capable of supporting a corresponding one of the paired supported portions so as to cause the tip-up frame to be self--standing on the base frame in a state where the tip-up frame is disposed at the fixed position and in a state before the paired supported portions are fixed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic side view of a vehicle seat according to an embodiment.

FIG. 2 is a perspective view of a cushion frame shown in FIG. 1.

FIG. 3 is an exploded perspective view showing the installation structure of the cushion frame shown in FIG. 1.

FIG. 4 is a side view of the cushion frame shown in FIG. 1.

FIG. 5 is a partial perspective side view of the cushion frame shown in FIG. 1.

FIG. 6 is a cross-sectional view taken along a line VI-VI shown in each of FIGS. 4 and 5.

FIG. 7 is a cross-sectional view taken along a line VII-VII shown in each of FIGS. 4 and 5.

FIG. 8 is a diagram showing the configuration in the vicinity of a supporting bracket of the cushion frame shown in FIG. 1.

FIG. 9 is a diagram showing the configuration in the vicinity of a hinge bracket of the cushion frame shown in FIG. 1.

FIG. 10 is an exploded perspective view showing the installation structure of the hinge bracket shown in FIG. 9.

FIG. 11 is an exploded perspective view showing a main part of the installation structure of the cushion frame shown in FIG. 1.

FIGS. 12 and 13 each are a diagram showing the state where a tip-up frame is positioned relative to a base frame during manufacturing of the vehicle seat shown in FIG. 1.

FIG. 14 is a diagram showing the state after the tip-up frame is positioned relative to the base frame during manufacturing of the vehicle seat shown in FIG. 1.

### DESCRIPTION OF THE PREFERRED EMBODIMENTS

In the following, embodiments will be described in detail with reference to the accompanying drawings. Each of the embodiments described below exemplifies the case where the characteristic configuration of the present disclosure is applied to a vehicle seat configured as a seat of an automobile. In the embodiments described below, the same or corresponding components are designated by the same reference characters, and description thereof will not be repeated.

In each of the figures, as seen from an occupant of a vehicle who sits on a vehicle seat, the forward direction and the rearward direction of the seat are represented as an X1 direction and an X2 direction, respectively, the leftward direction and the rightward direction of the seat are represented as a Y1 direction and a Y2 direction, respectively, and the upward direction and the downward direction of the seat are represented as a Z1 direction and a Z2 direction, respectively. In the following description, the axis extending in forward direction X1 and rearward direction X2 of the seat will be referred to as an X axis, the axis extending in leftward direction Y1 and rightward direction Y2 of the seat will be referred to as a Y axis, and the axis extending in upward direction Z1 and downward direction Z2 of the seat will be referred to as a Z axis.

### 1. Configuration of Vehicle Seat

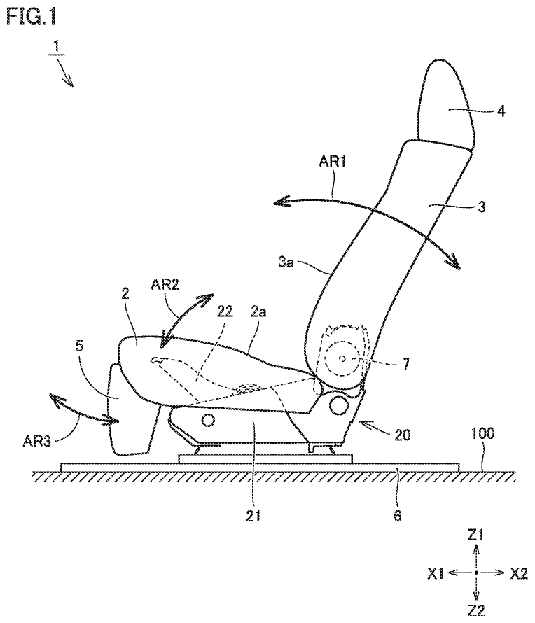

FIG. 1 is a schematic side view of a vehicle seat according to an embodiment. First, the configuration of a vehicle seat 1 will be described with reference to FIG. 1.

As shown in FIG. 1, vehicle seat 1 is installed on a floor 100 of a vehicle, for example, with a slide mechanism 6 interposed therebetween. Vehicle seat 1 mainly includes a seat cushion 2, a seat back 3, a headrest 4, and an ottoman 5.

Seat cushion 2 has an upper surface provided with a seat surface 2a on which an occupant of the vehicle can be seated. Seat cushion 2 is disposed such that seat surface 2a is approximately in parallel with floor 100 of the vehicle. Seat back 3 has a front surface provided with a backrest surface 3a on which the occupant of the vehicle can lean. Seat back 3 is disposed so as to be raised from the rear end portion of seat cushion 2. Headrest 4 is attached to the upper end portion of seat back 3. Ottoman 5 is attached to the front end portion of seat cushion 2.

A cushion frame 20 formed as a framework of seat cushion 2 is provided inside seat cushion 2. A back frame (not shown) formed as a framework of seat back 3 is provided inside seat back 3. The back frame has a lower end portion that is coupled to the rear end portion of cushion frame 20 through a recliner 7. Thereby, seat back 3 is configured to be pivotable in the direction indicated by an arrow AR1 shown in the figure about the position at which recliner 7 is provided. Accordingly, the backrest angle of seat back 3 can be adjusted by operating a lever (not shown) or the like.

Cushion frame 20 mainly includes a base frame 21 and a tip-up frame 22. Base frame 21 is fixed to floor 100 of the vehicle with slide mechanism 6 interposed therebetween. On the other hand, tip-up frame 22 is pivotably installed in base frame 21. Thereby, seat cushion 2 pivots in the direction indicated by an arrow AR2 shown in the figure. Thus, by operating a lever (not shown) or the like, seat cushion 2 can be brought into a tipped-up state, for example, particularly when vehicle seat 1 is not used.

An ottoman frame (not shown) formed as a framework of ottoman 5 is provided inside ottoman 5 and attached to the front end portion of cushion frame 20. Ottoman 5 is configured to be movable between the stored position and the extended position as the ottoman frame is moved approximately in the direction indicated by an arrow AR3 shown in the figure. Accordingly, a lever (not shown) or the like is operated to move particularly ottoman 5 to the extended position, so that ottoman 5 can be used as a footrest.

### 2. Configuration and Schematic Installation Structure of Cushion Frame

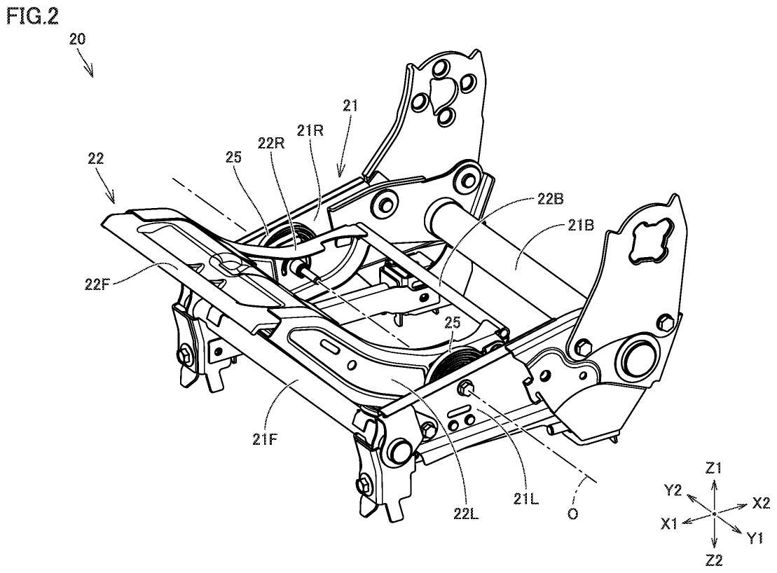

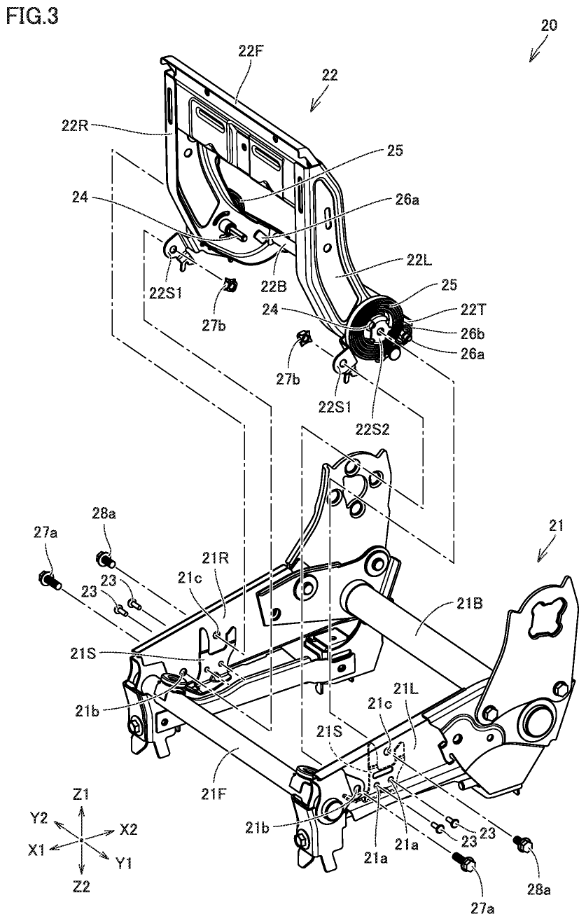

FIG. 2 is a perspective view of the cushion frame shown in FIG. 1. FIG. 3 is an exploded perspective view showing the installation structure of the cushion frame. Then, referring to FIGS. 2 and 3, the configuration and the schematic installation structure of cushion frame 20 of vehicle seat 1 will be hereinafter described. FIGS. 2 and 3 each show only the basic configuration of cushion frame 20 in order to allow easy understanding.

Referring to FIGS. 2 and 3, cushion frame 20 includes base frame 21 and tip-up frame 22, as described above. Base frame 21 and tip-up frame 22 each have a rectangular frame shape as seen in a plan view. Tip-up frame 22 is disposed inside base frame 21 in the seat width direction (that is, the Y-axis direction).

Base frame 21 is covered by an exterior cover (not shown). Base frame 21 has: side frames 21L and 21R as a pair of left and right frames; a front pipe 21F and a rear pipe 21B as a pair of front and rear frames. Among them, side frames 21L and 21R as a pair of left and right frames form a pair of first side wall portions of base frame 21 that are located to face each other in the seat width direction.

Each of side frames 21L and 21R is formed of a press-molded product produced, for example, by press-working a metal plate such as a steel plate, and disposed to extend in the seat front-rear direction (that is, the X-axis direction). Each of front pipe 21F and rear pipe 21B is formed of a metal-made hollow cylindrical member such as a steel pipe, for example, and disposed to extend in the seat width direction (that is, the Y-axis direction). Front pipe 21F couples the front end portions of side frames 21L and 21R while rear pipe 21B couples the rear end portions of side frames 21L and 21R.

Tip-up frame 22 is covered by a cushion cover and a cushion pad (not shown) defining seat surface 2a. Tip-up frame 22 has: side frames 22L and 22R as a pair of left and right frames; and a front panel 22F and a rear pipe 22B as a pair of front and rear frames. Among them, side frames 22L and 22R as a pair of left and right frames form a pair of second side wall portions of tip-up 22 that are located to face each other in the seat width direction.

Each of side frames 22L and 22R is formed of a press-molded product produced, for example, by press-working a metal plate such as a steel plate, and disposed to extend in the seat front-rear direction (that is, the X-axis direction). Front panel 22F is formed of a press-molded product produced, for example, by press-working a metal plate such as a steel plate, and disposed to extend in the seat width direction (that is, the Y-axis direction). Rear pipe 22B is formed of a metal-made hollow cylindrical member such as a steel pipe, for example, and disposed to extend in the seat width direction (that is, the Y-axis direction). Front panel 22F couples the front end portions of side frames 22L and 22R while rear pipe 22B couples the rear end portions of side frames 22L and 22R.

The rear end portions of side frames 22L and 22R of tip-up frame 22 are connected to respective side frames 21L and 21R of base frame 21 through a pair of respective left and right hinge portions, which will be described later. Thereby, tip-up frame 22 is supported by base frame 21 so as to be pivotable about a rotation axis O (see FIG. 2).

In this case, rotation axis O of tip-up frame 22 is disposed to cross side frames 21L and 21R of base frame 21. Thus, the rear end portion of tip-up frame 22 and base frame 21 partially overlap with each other in the seat width direction (that is, the Y-axis direction). By the configuration as described above, cushion frame 20 formed of base frame 21 and tip-up frame 22 can be reduced in thickness in the seat up-down direction.

Furthermore, a pair of left and right biasing springs 25 is provided such that left biasing spring 25 is located adjacent to the left hinge portion of the above-mentioned pair of left and right hinge portions between side frame 22L of tip-up frame 22 and side frame 21L of base frame 21, and such that right biasing spring 25 is located adjacent to the right hinge portion of the above-mentioned pair of left and right hinge portions between side frame 22R of tip-up frame 22 and side frame 21R of base frame 21. Each of these paired left and right biasing springs 25 corresponds to a corresponding one of paired biasing members located to face each other in the seat width direction (that is, the Y-axis direction), and is formed of a spiral spring, for example.

In this case, tip-up frame 22 is biased by the pair of biasing springs 25 in the direction in which tip-up frame 22 is tipped up toward seat back 3 in the direction in which tip-up frame 22 pivots (that is, in the direction in which the front end portion of tip-up frame 22 approaches seat back 3). Furthermore, tip-up frame 22 is configured such that its pivoting movement is restricted by a lock mechanism (not shown) against the biasing force from the pair of biasing springs 25. Thus, a lever or the like is operated to unlock the lock mechanism, thereby causing tip-up frame 22 to pivot, so that seat cushion 2 is tipped up, as described above.

As shown in FIG. 3, side frames 21L and 21R of base frame 21 are provided with respective paired left and right supporting brackets 21S as a pair of supporting portions that are located to face each other in the seat width direction (that is, the Y-axis direction). One of paired supporting brackets 21S is fixed to the inner wall surface of side frame 21L in the seat width direction while the other one of paired supporting brackets 21S is fixed to the inner wall surface of side frame 21R in the seat width direction.

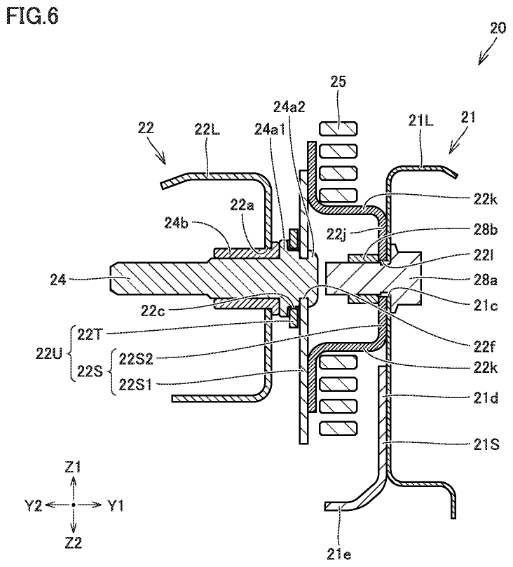

Side frames 22L and 22R of tip-up frame 22 are provided with respective paired left and right hinge brackets 22U (see FIG. 5 and the like) that are located to face each other in the seat width direction (that is, the Y-axis direction). One of paired hinge brackets 22U is fixed to the outer wall surface of side frame 22L in the seat width direction while the other one of paired hinge brackets 22U is fixed to the outer wall surface of side frame 22R in the seat width direction.

Each of paired hinge brackets 22U includes a first bracket 22S1, a second bracket 22S2 (FIG. 3 shows only one of two second brackets 22S2), and an auxiliary bracket 22T (FIG. 3 shows only one of two auxiliary brackets 22T). Among them, two first brackets 22S1 and two second brackets 22S2 excluding two auxiliary brackets 22T form a pair of supported brackets 22S (see FIG. 5 and the like) as a pair of supported portions that are located to face each other in the seat width direction (that is, the Y-axis direction).

In the state after tip-up frame 22 is installed in base frame 21, one of paired hinge brackets 22U is fixed not only to the outer wall surface of side frame 22L in the seat width direction (that is, the Y-axis direction) but also to the inner wall surface of side frame 21L of base frame 21 in the seat width direction while the other one of paired hinge brackets 22U is fixed not only to the outer wall surface of side frame 22R in the seat width direction but also to the inner wall surface of side frame 21R of base frame 21 in the seat width direction.

Furthermore, paired left and right hinge brackets 22U are equipped with respective paired left and right hinge pins 24 that are located to face each other in the seat width direction (that is, the Y-axis direction). One of paired hinge pins 24 is attached to one of paired hinge brackets 22U while the other one of paired hinge pins 24 is attached to the other one of paired hinge brackets 22U.

Furthermore, paired left and right hinge brackets 22U are equipped with respective paired left and right biasing springs 25 (mentioned above) that are located to face each other in the seat width direction (that is, the Y-axis direction). One of paired biasing springs 25 is attached to one of paired hinge brackets 22U while the other one of paired biasing springs 25 is attached to the other one of paired hinge brackets 22U.

The pair of supporting brackets 21S, the pair of hinge brackets 22U, the pair of hinge pins 24, and the pair of biasing springs 25 described above form a pair of left and right connection portions through which tip-up frame 22 is pivotably connected to base frame 21. Among them, the pair of supporting brackets 21S, the pair of hinge brackets 22U and the pair of hinge pins 24 form the above-described pair of left and right hinge portions.

More specifically, one of paired supporting brackets 21S, one of paired hinge brackets 22U, one of paired hinge pins 24, and one of paired biasing springs 25 serve to connect side frame 21L of base frame 21 and side frame 22L of tip-up frame 22 on the left side of cushion frame 20 in the seat width direction (that is, the Y-axis direction). The other one of paired supporting brackets 21S, the other one of paired hinge brackets 22U, the other one of paired hinge pins 24, and the other one of paired biasing springs 25 serve to connect side frame 21R of base frame 21 and side frame 22R of tip-up frame 22 on the right side of cushion flame 20 in the seat width direction.

As shown in FIG. 3, tip-up frame 22 is installed in base frame 21 by fixing paired supporting brackets 21S to base frame 21 in advance, and fixing paired hinge brackets 22U to tip-up frame 22 in advance, and then, placing tip-up frame 22 on base frame 21 such that paired hinge brackets 22U are supported by paired supporting brackets 21S, in which state paired hinge brackets 22U are fixed to base frame 21, as will be described later in detail.

In this case, one and the other one of paired supporting brackets 21S described above are configured in mirror symmetry in the seat width direction (that is, the Y-axis direction). Also, one and the other one of paired hinge brackets 22U described above are configured in mirror symmetry in the seat width direction (that is, the Y-axis direction). Furthermore, one and the other one of paired hinge pins 24 described above are configured in mirror symmetry in the seat width direction. Also, one and the other one of paired biasing springs 25 described above are configured in mirror symmetry in the seat width direction.

Thereby, the structure of installation of base frame 21 in tip-up frame 22 is substantially the same on the left and right sides of cushion frame 20 in the seat width direction except that the above-described paired connection portions are configured in mirror symmetry. Thus, the following explanation will be given while focusing attention on the installation structure of cushion frame 20 on the left side in the seat width direction, which is included in the structure of installation of tip-up frame 22 in base frame 21.

### 3. Detailed Installation Structure of Cushion Frame

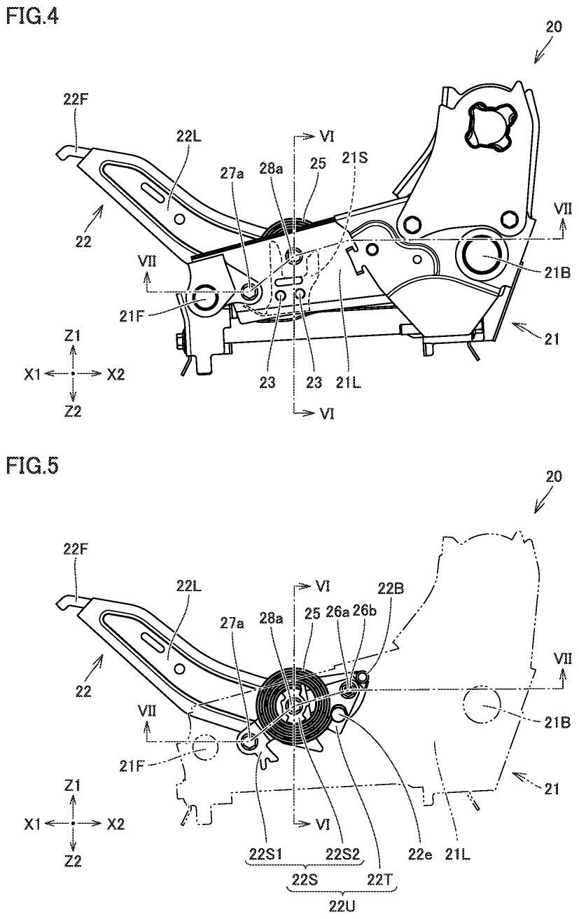

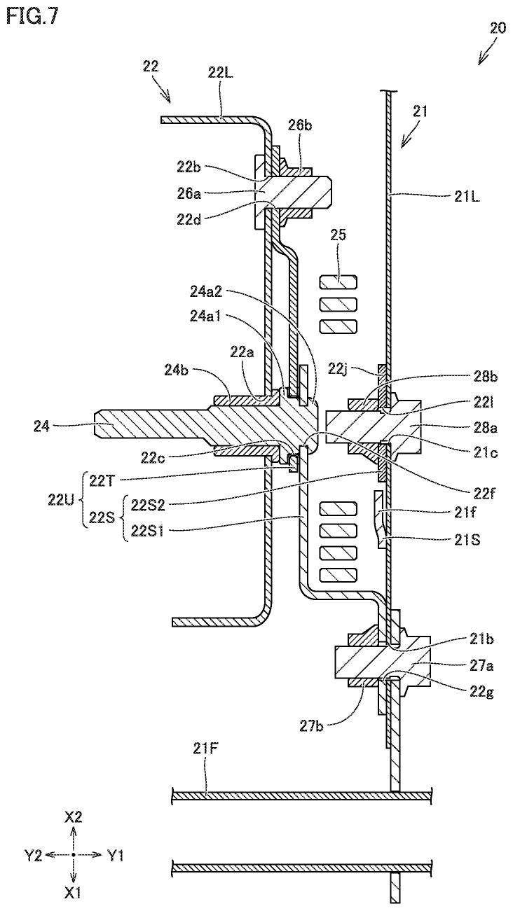

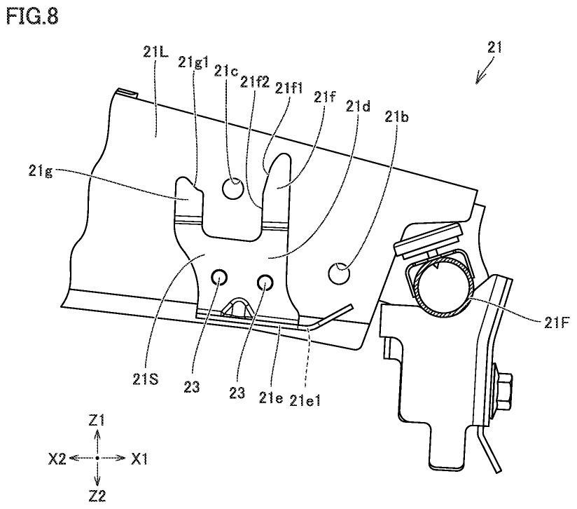

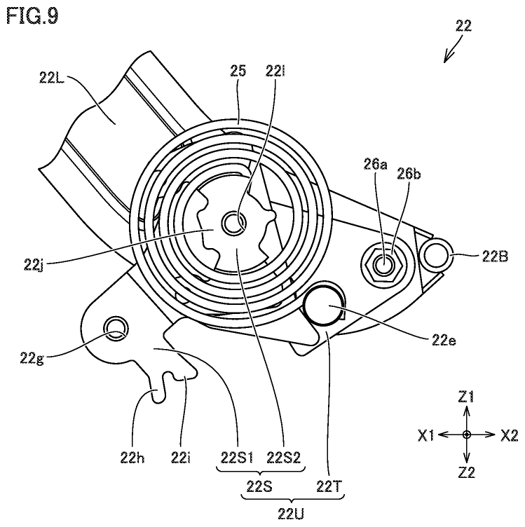

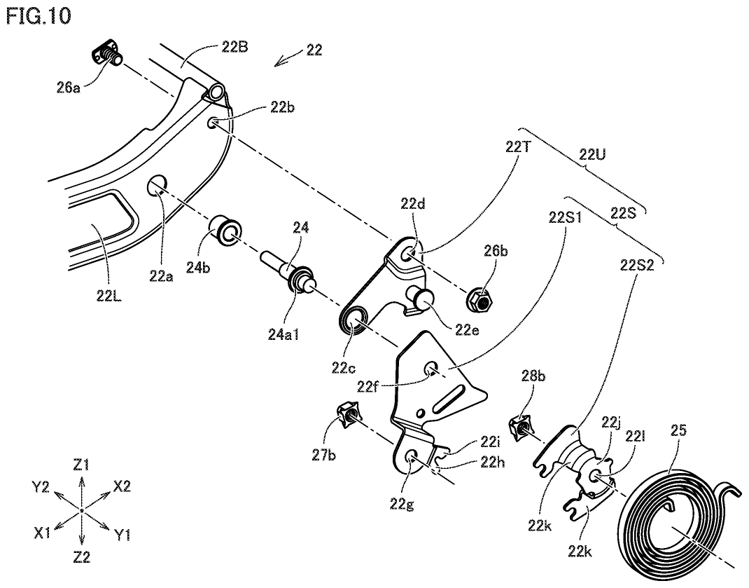

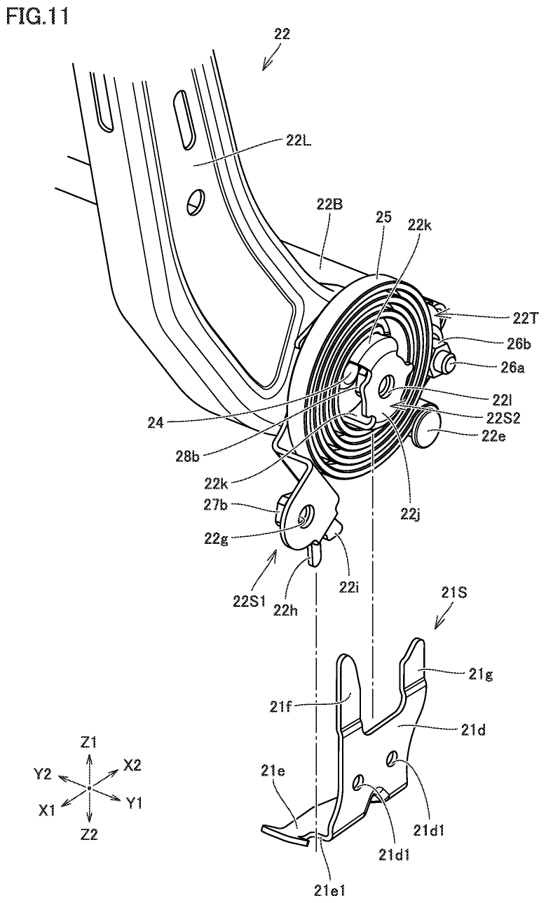

FIGS. 4 and 5 are a side view and a partial perspective side view, respectively, of the cushion frame shown in FIG. 1. FIGS. 6 and 7 are cross-sectional views taken along a line VI-VI line shown in FIG. 4 and a line VII-VII shown in FIG. 5, respectively. FIG. 8 is a diagram showing the configuration in the vicinity of the supporting bracket of the cushion frame shown in FIG. 1. FIG. 9 is a diagram showing the configuration in the vicinity of the hinge bracket of the cushion frame. FIG. 10 is an exploded perspective view showing the installation structure of the hinge bracket shown in FIG. 9. Then, the details of the installation structure of cushion frame 20 in vehicle seat 1 will be described with reference to these FIGS. 4 to 10 and the above-mentioned FIG. 3. FIGS. 4 to 10 each show only the basic configuration of cushion frame 20 in order to allow easy understanding. FIGS. 8 and 9 each show the state before tip-up frame 22 is installed in base frame 21 (that is, the state shown in FIG. 3).

### 3-1. Supporting Bracket

Referring to FIGS. 3, 4 and 6 to 8, supporting bracket 21S is fixed to the inner wall surface of side frame 21L of base frame 21, as described above. Supporting bracket 21S is formed of a plate-shaped bracket made of a press-molded product produced by press-working a metal plate such as a steel plate, for example.

As shown in FIGS. 6 to 8 (particularly, FIG. 8), supporting bracket 21S is provided with a base portion 21d, a bottom portion 21e located at the lower end of base portion 21d, and a front-side protruding portion 21f and a rear-side protruding portion 21g that are located at the upper end of base portion 21d.

Base portion 21d is fixed to side frame 21L in the state where this base portion 21d is pressed against the inner wall surface of side frame 21L of base frame 21. More specifically, supporting bracket 21S is fixed to side frame 21L at base portion 21d by using both welding and fastening using a rivet 23 (see FIGS. 3, 4 and 8) as a fastening member.

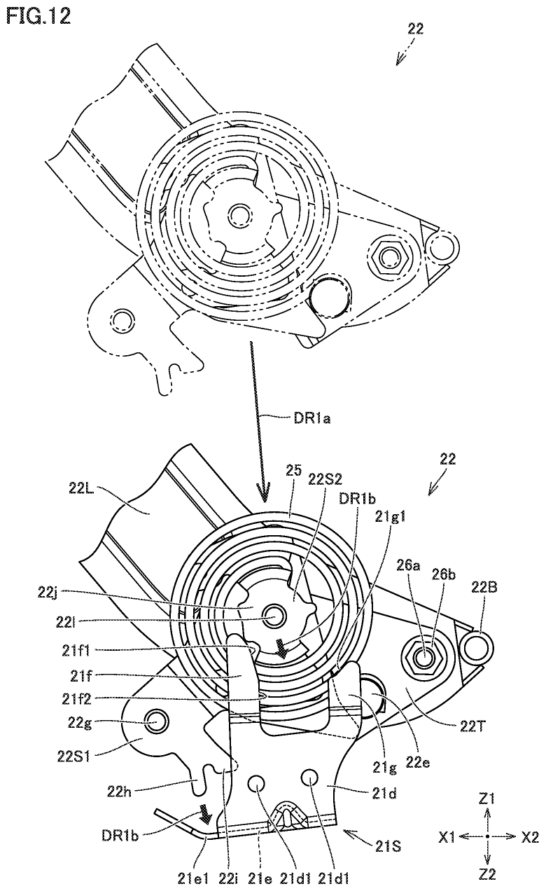

Among them, fastening using rivet 23 is implemented as follows. Specifically, base portion 21d is pressed against the inner wall surface of side frame 21L such that a through hole 21a (see FIG. 3) provided in base portion 21d of supporting bracket 21S overlaps with a through hole 21d1 provided in side frame 21L (see FIGS. 11 to 14). In this state, rivet 23 is then inserted into these through holes 21a and 21d1 and the tip end of rivet 23 is deformed.

Bottom portion 21e is vertically arranged from the lower end of base portion 21d toward the inside (that is, in the Y2 direction) in the seat width direction (that is, the Y-axis direction). Bottom portion 21e is provided with a cutout portion at its prescribed position. This cutout portion is disposed to face side frame 21L, so that an engagement hole portion 21e1 (see FIGS. 8, 11 and the like) is provided in bottom portion 21e. Bottom portion 21e and engagement hole portion 21e1 serve to cause tip-up frame 22 to be self-standing on base frame 21 during installation, which will be described later in detail.

Front-side protruding portion 21f is provided to extend from the front side portion of the upper end of base portion 21d in the seat front-rear direction (that is, in the X-axis direction) to the upward direction (that is, in the Z1 direction) in the seat up-down direction (that is, in the Z-axis direction). At the rear end of front-side protruding portion 21f in the seat front-rear direction, a guide portion 21f1 formed of an inclined surface and a restriction portion 21f2 formed of a vertical plane are provided. Guide portion 21f1 serves to guide tip-up frame 22 to the fixed position in base frame 21 during installation, which will be described later in detail. Restriction portion 21f2 serves to cause tip-up frame 22 to be self-standing on base frame 21 during installation, which will be described later in detail.

Rear-side protruding portion 21g is provided to extend from the rear side portion of the upper end of base portion 21d in the seat front-rear direction (that is, in the X-axis direction) to the upward direction (that is, in the Z1 direction) in the seat up-down direction (that is, in the Z-axis direction). At the front end of rear-side protruding portion 21g in the seat front-rear direction, a guide portion 21g1 formed of an inclined surface is provided. Guide portion 21g1 serves to guide tip-up frame 22 to the fixed position in base frame 21 during installation, which will be described later in detail.

Thereby, supporting bracket 21S is provided with a recessed receiving portion that is opened at its upper end in the seat up-down direction (that is, in the Z-axis direction) and that is formed to become narrow from the upper end to the downward direction. The receiving portion is defined by the upper end of base portion 21d (described above), the rear end of front-side protruding portion 21f, and the front end of rear-side protruding portion 21g.

As shown in FIGS. 3 and 8, two through holes 21b and 21c are provided in side frame 21L in the vicinity of the portion to which supporting bracket 21S is fixed. These two through holes 21b and 21c are used for fixing hinge bracket 22L to side frame 21L, which will be described later in detail.

### 3-2. Hinge Bracket, Hinge Pin and Biasing Spring

Referring to FIGS. 3, 5 to 7, 9, and 10, hinge bracket 22U is fixed to the outer wall surface of side frame 22L of tip-up frame 22 and also fixed to the inner wall surface of side frame 21L of base frame 21, as described above. Also, hinge bracket 22U includes: first bracket 22S1 and second bracket 22S2 as supported bracket 22S, and auxiliary bracket 22T, as described above. These first bracket 22S1, second bracket 22S2 and auxiliary bracket 22T each are formed of a plate-shaped bracket made of a press-molded product produced by press-working a metal plate such as a steel plate, for example.

Auxiliary bracket 22T is fixed to the outer wall portion of side frame 22L of tip-up frame 22. Thereby, auxiliary bracket 22T forms the above-described second side wall portion together with side frame 22L.

Auxiliary bracket 22T is provided with a hinge hole 22c, a through hole 22d and a hook pin 22e. Hinge hole 22c is a part into which hinge pin 24 is rotatably inserted. Through hole 22d is a part through which auxiliary bracket 22T is fixed to side frame 22L. Hook pin 22e is a part over which one end of biasing spring 25 formed of a spiral spring is hooked.

First bracket 22S1 and second bracket 22S2 that form supported bracket 22S are, for example, welded to each other so as to be formed as an integrated single component. Supported bracket 22S is pivotably attached to side frame 22L of tip-up frame 22 and also immovably fixed to side frame 21L of base frame 21.

First bracket 22S1 is disposed on the inner side of second bracket 22S2 in the seat width direction (that is, in the Y-axis direction). First bracket 22S1 is provided with a hinge hole 22f, a through hole 22g, an engagement protrusion 22h protruding downward, and a contact portion 22i facing downward.

Hinge hole 22f is a part into which hinge pin 24 is rotatably inserted. Through hole 22g is a part through which first bracket 22S1 is fixed to side frame 21L of base frame 21. Furthermore, engagement protrusion 22h and contact portion 22i serve to cause tip-up frame 22 to be self-standing on base frame 21 during installation, which will be described later in detail.

Second bracket 22S2 is disposed on the outer side of first bracket 22S1 in the seat width direction (that is, in the Y-axis direction). Second bracket 22S2 is provided with a mount portion 22j, a pair of leg portions 22k, and a through hole 22l. The pair of leg portions 22k is vertically arranged from the outer edge of mount portion 22j toward the inside in the seat width direction. The ends of paired leg portions 22k are fixed to first bracket 22S1. Furthermore, through hole 22l is provided in mount portion 22j.

By mount portion 22j and the pair of leg portions 22k mentioned above, second bracket 22S2 is provided with a protruding portion that protrudes in the seat width direction (that is, in the Y-axis direction). This protruding portion serves as a guided portion when tip-up frame 22 is guided to its fixed position by base frame 21 during installation, which will be described later in detail.

Furthermore, mount portion 22j and the pair of leg portions 22k serve to secure the space in which the head of hinge pin 24, the tip end of a bolt 28a and a nut 28b (which will be described later) are housed between first bracket 22S1 and second bracket 22S2 such that the head of hinge pin 24 does not interfere with the tip end of bolt 28a and nut 28b. Mount portion 22j and the pair of leg portions 22k also serve to secure the space in which biasing spring 25 formed of a spiral spring is housed. Furthermore, one of paired leg portions 22k also serves as a part over which the other end on the opposite side of the above-described one end of biasing spring 25 formed of a spiral spring is hooked. Through hole 22l is a part through which second bracket 22S2 is fixed to side frame 21L of base frame 21.

In this case, the above-described fixation of auxiliary bracket 22T to side frame 22L of tip-up frame 22 is implemented by using both welding and fastening using a bolt 26a and a nut 26b as fastening members.

As shown in FIGS. 3, 5, 7, 9, and 10 (particularly FIGS. 7 and 10), fastening using bolt 26a and nut 26b is performed as follows. Specifically, auxiliary bracket 22T is pressed against the outer wall surface of side frame 22L such that through hole 22d provided in auxiliary bracket 22T and through hole 22b provided in side frame 22L overlap with each other. In this state, bolt 26a is inserted into through holes 22d and 22b, and then, nut 26b is screwed into the tip end of bolt 26a. It is preferable that nut 26b is fixed to auxiliary bracket 22T in advance by welding or the like for the purpose of improving the installability.

Furthermore, the above-described installation of supported bracket 22S in side frame 22L of tip-up frame 22 is implemented by mainly using hinge pin 24 to connect first bracket 22S1 of supported bracket 22S to side frame 22L and auxiliary bracket 22T fixed to side frame 22L.

As shown in FIGS. 6, 7 and 10, connection using hinge pin 24 is implemented as follows. Specifically, first bracket 22S1 and auxiliary bracket 22T are pressed against the outer wall surface of side frame 22L such that hinge hole 22f provided in first bracket 22S1, hinge hole 22c provided in auxiliary bracket 22T and hinge hole 22a provided in side frame 22L overlap with one another. In this state, hinge pin 24 is inserted into hinge holes 22f, 22c, and 22a.

In this case, in order to improve the installability and the slidability, it is preferable that a cylindrical color 24b having a hollow portion through which hinge pin 24 can be inserted is fitted in advance in hinge hole 22a provided in side frame 22L, and this color 24b is fixed to side frame 22L by welding or the like. Also due to the same reason, for the purpose of immovably fixing hinge pin 24 to first bracket 22S1 and also securing the space in which auxiliary bracket 22T is pivotable, it is preferable that a flange portion 24a1 is provided in advance in hinge pin 24 to thereby fix hinge pin 24 to first bracket 22S1 by swaging.

After installation, hinge pin 24 holds first bracket 22S1 so as to be sandwiched between flange portion 24a1 provided in advance at the mid position of hinge pin 24 in the axial direction and a swaged portion 24a2 formed by plastic deformation of one end of hinge pin 24 in the axial direction during installation. Furthermore, flange portion 24a1 of hinge pin 24 is further provided with a stepped portion on which auxiliary bracket 22T is pivotably arranged. Thereby, the installability and the slidability are improved. In addition, in place of the above-described swaged portion 24a2, one end of hinge pin 24 in the axial direction may be fixed to first bracket 22S1 by welding.

Furthermore, the above-described fixation of supported bracket 22S to side frame 21L of base frame 21 is implemented by fixing each of first bracket 22S1 and second bracket 22S2 to side frame 21L.

As shown in FIGS. 3 to 5, 7, and 10, first bracket 22S1 is fixed to side frame 21L by fastening using a bolt 27a and a nut 27b as fastening members.

This fastening using bolt 27a and nut 27b is implemented as follows. Specifically, first bracket 22S1 is pressed against the inner wall surface of side frame 21L such that through hole 22g provided in first bracket 22S1 and through hole 21b provided in side frame 21L overlap with each other. In this state, bolt 27a is inserted into these through holes 22g and 21b, so that nut 27b is screwed into the tip end of bolt 27a. For the purpose of improving the installability, it is preferable that nut 27b is fixed to first bracket 22S1 in advance by welding or the like.

As shown in FIGS. 3 to 7 and 10, second bracket 22S2 is fixed to side frame 21L by fastening using bolt 28a and nut 28b as fastening members.

This fastening using bolt 28a and nut 28b is implemented as follows. Specifically, second bracket 22S2 is pressed against the inner wall surface of side frame 21L such that through hole 22l provided in second bracket 22S2 and through hole 21c provided in side frame 22L overlap with each other. In this state, bolt 28a is inserted into these through holes 22l and 21c, so that nut 28b is screwed into the tip end of bolt 28a. In addition, for the purpose of improving the installability, it is preferable that nut 28b is fixed to second bracket 22S2 in advance by welding or the like.

As shown in FIGS. 3, 5 to 7, 9, and 10, biasing spring 25 formed of a spiral spring is attached to hinge bracket 22U so as to surround the above-described protruding portion of second bracket 22S2 (that is, a part defined by mount portion 22j and the pair of leg portions 22k). More specifically, biasing spring 25 is extended under tension between supported bracket 22S and auxiliary bracket 22T in the state where one end of biasing spring 25 is hooked over hook pin 22e of auxiliary bracket 22T while the other end of biasing spring 25 is hooked over one of paired leg portions 22k of second bracket 22S2.

In this case, regarding fixation, connection and extension under tension between members as described above, fixation of supporting bracket 21S to side frame 21L; fixation of auxiliary bracket 22T to side frame 22L; fixation and connection of supported bracket 22S to side frame 22L and auxiliary bracket 22T; and extension of biasing spring 25 under tension between supported bracket 22S and auxiliary bracket 22T are performed before installation of tip-up frame 22 in base frame 21, as shown in FIGS. 8 and 9.

Also, regarding fixation, connection and extension under tension between members as described above, fixation of supported bracket 22S to side frame 21L (that is, fixation of first bracket 22S1 and second bracket 22S2 to side frame 21L) is performed when tip-up frame 22 is installed in base frame 21.

In this case, in vehicle seat 1 according to the present embodiment, as described above, supporting bracket 21S is provided with bottom portion 21e, engagement hole portion 21e1, front-side protruding portion 21f, guide portion 21f1, restriction portion 21f2, rear-side protruding portion 21g, guide portion 21g1, a receiving portion, and the like each having a prescribed shape while supported bracket 22S is provided with engagement protrusion 22h, contact portion 22i, a protruding portion and the like each having a prescribed shape.

Thereby, supporting bracket 21S is configured to guide supported bracket 22S so that tip-up frame 22 can be brought to the fixed position in base frame 21 during installation of tip-up frame 22 in base frame 21, and also configured to be capable of supporting supported bracket 21S to allow tip-up frame 21 to be self-standing on base frame 22 in the state where tip-up frame 22 is disposed at the fixed position and in the state before supported bracket 22S is fixed.

Thus, according to vehicle seat 1 in the present embodiment, installation of tip-up frame 22 in base frame 21 is significantly simplified, which will be described below in detail together with a specific method of installing tip-up frame 22 in base frame 21.

### 4. Method of Installing Tip-Up Frame in Base Frame

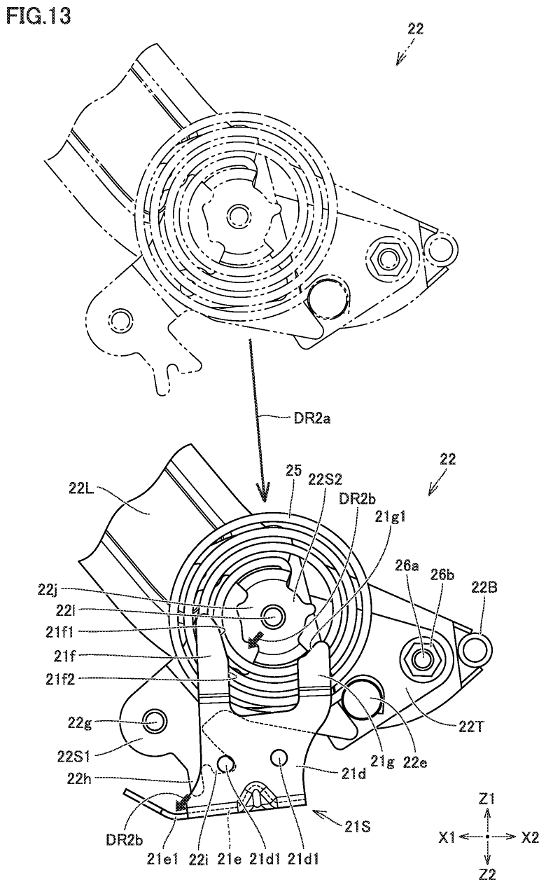

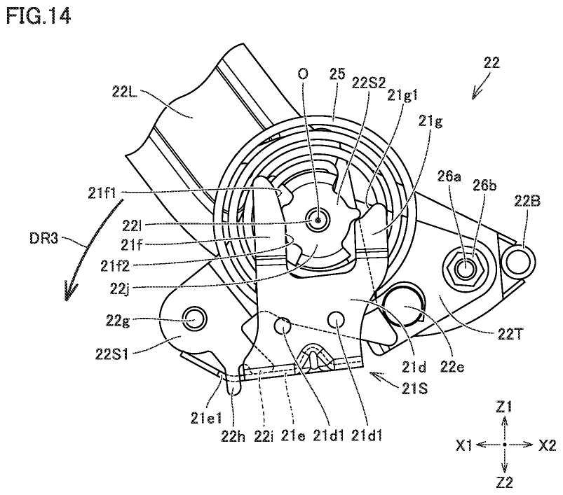

FIG. 11 is an exploded perspective view showing a main part of the installation structure of the cushion frame shown in FIG. 1. FIGS. 12 and 13 each are a diagram showing the state where the tip-up frame is positioned relative to the base frame during manufacturing of the vehicle seat shown in FIG. 1. FIG. 14 is a diagram showing the state after the tip-up frame is positioned relative to the base frame during manufacturing of the vehicle seat. FIGS. 11 to 14 each show only the basic configuration of cushion frame 20 in order to allow easy understanding.

Referring to FIGS. 11 to 14 and the above-mentioned FIG. 3, tip-up frame 22 is installed in base frame 21 by fitting tip-up frame 22 into base frame 21 in the direction orthogonal to the seat width direction (that is, the Y-axis direction).

More specifically, for installation, tip-up frame 22 equipped in advance with hinge bracket 22U, hinge pin 24 and biasing spring 25 is first moved downward (that is, in the Z2 direction) approximately in the Z-axis direction toward base frame 21 equipped in advance with supporting bracket 21S, as shown in FIGS. 3 and 11 to 13.

In this case, as shown in FIGS. 12 and 13, the protruding portion of hinge bracket 22U (that is, a part defined by mount portion 22j and paired leg portions 22k provided in second bracket 22S2) is adjusted in position so as to be inserted into the receiving portion of supporting bracket 21S (that is, a recessed portion defined by base portion 21d, front-side protruding portion 21f and rear-side protruding portion 21g provided in supporting bracket 21S).

In this case, FIG. 12 shows the case where the position of the protruding portion relative to the receiving portion is located slightly frontward in the seat front-rear direction (that is, the X-axis direction). FIG. 13 shows the case where the position of the protruding portion relative to the receiving portion is located slightly rearward in the seat front-rear direction.

As shown in FIG. 12, when the position of the protruding portion relative to the receiving portion is located slightly frontward, the protruding portion is moved in the direction indicated by an arrow DR1a shown in the figure, so that the frontward portion of the protruding portion is brought into contact with guide portion 21f1 formed in an inclined shape and located at the rear end of front-side protruding portion 21f that defines the receiving portion. After this contact, the protruding portion is guided by guide portion 21f1, so that the movement direction of the protruding portion is changed from an initial DR1a direction to a DR1b direction shown in the figure (that is, diagonally rearward in the downward direction). Thereby, the protruding portion is guided into the receiving portion.

Also in this case, as the protruding portion is guided by guide portion 21f1, engagement protrusion 22h of hinge bracket 22U is guided into engagement hole portion 21e1 provided in bottom portion 21e of supporting bracket 21S. Also, as the protruding portion is guided by guide portion 21f1, contact portion 22i of hinge bracket 22U is guided toward bottom portion 21e provided in bottom portion 21e of supporting bracket 21S.

As shown in FIG. 13, when the position of the protruding portion relative to the receiving portion is located slightly rearward, the protruding portion is moved in the direction indicated by an arrow DR2a shown in the figure, so that the rearward portion of the protruding portion is brought into contact with guide portion 21g1 formed in an inclined shape and located at the front end of rear-side protruding portion 21g that defines the receiving portion. After this contact, the protruding portion is guided by guide portion 21g1, so that the movement direction of the protruding portion is changed from an initial DR2a direction to a DR2b direction shown in the figure (that is, diagonally forward in the downward direction). Thereby, the protruding portion is guided into the receiving portion.

Also in this case, as the protruding portion is guided by guide portion 21g1, engagement protrusion 22h of hinge bracket 22U is guided into engagement hole portion 21e1 provided in bottom portion 21e of supporting bracket 21S. Also, as the protruding portion is guided by guide portion 21g1, contact portion 22i of hinge bracket 22U is guided toward bottom portion 21e provided in bottom portion 21e of supporting bracket 21S.

Thereby, as shown in FIG. 14, the protruding portion is guided into the receiving portion and housed in the receiving portion, so that tip-up frame 22 reaches the fixed position in base frame 21.

In the state where tip-up frame 22 reaches the fixed position in base frame 21 the frontward portion of the protruding portion comes into contact with restriction portion 21f2 located at the rear end of front-side protruding portion 21f that defines the receiving portion. Also, engagement protrusion 22h is inserted into engagement hole portion 21e1, and further, contact portion 22i comes into contact with bottom portion 21e. Accordingly, in this state, hinge bracket 22U is supported by supporting bracket 21S, thereby maintaining the state where tip-up frame 22 is kept self-standing on base frame 21.

Furthermore, in the state where tip-up frame 22 reaches the fixed position in base frame 21, through holes 22g and 22l provided in hinge bracket 22U overlap with through holes 21b and 21c, respectively, provided in side frame 21L. Accordingly, as shown in FIG. 3, bolt 27a is then inserted into through holes 22g and 21b overlapping with each other and screwed into nut 27b while bolt 28a is inserted into through holes 22l and 21c overlapping with each other and screwed into nut 28b. Thereby, hinge bracket 22U is fixed to side frame 21L.

In this case, in the state immediately after tip-up frame 22 is pivotably installed in base frame 21 according to the above-described installing method, tip-up frame 22 is tipped up by the biasing force from the pair of biasing springs 25. Thus, if required in the subsequent process during manufacturing of vehicle seat 1, as shown in FIG. 14, tip-up frame 22 is pivoted in the direction indicated by an arrow DR3 shown in the figure and locked by the lock mechanism (not shown), with the result that vehicle seat 1 can also be brought into the state where an occupant of the vehicle can be seated thereon.

In the above description, among the methods of installing tip-up frame 22 in base frame 21, only the installing method applied on the left side of cushion frame 20 in the seat width direction has been explained, which is however the same as the installing method applied on the right side of cushion frame 20 in the seat width direction. Thus, installations on the right and left sides in the seat width direction are concurrently performed.

### 5. Effects

According to vehicle seat 1 in the present embodiment described above, each of paired left and right supported brackets 22S of tip-up frame 22 fixed to base frame 21 is pivotably provided in advance in a corresponding one of paired left and right side frames 22L and 22R of tip-up frame 22, so that tip-up frame 22 can be pivotably installed in base frame 21 in a simple operation of fixing each of paired supported brackets 22S to base frame 21.

In this case, by the configuration in which paired left and right supported brackets 22S of tip-up frame 22 are guided to the fixed position by respective paired left and right supporting brackets 21S of base frame 21, tip-up frame 22 can be readily positioned relative to base frame 21. Furthermore, by the configuration in which tip-up frame 22 is allowed to be self-standing on base frame 21 while being disposed at the fixed position, the state after positioning is maintained by paired left and right supporting brackets 21S. Thus, the operation of fixing paired left and right supported brackets 22S of tip-up frame 22 to base frame 21 can also be readily performed.

Accordingly, the configuration as described above can lead to the effect of significantly simplifying installation of tip-up frame 22 in base frame 21.

In this case, by the configuration in which the width of the opened upper end of the receiving portion mentioned above (that is, the magnitude in the X-axis direction) is sufficiently wider than the width of the protruding portion mentioned above (that is, the magnitude in the X-axis direction), elaborate alignment of the protruding portion with the receiving portion does not necessarily have to be done. In other words, by rough alignment of these portions, supported bracket 22S is subsequently guided by supporting bracket 21S, with the result that tip-up frame 22 is smoothly guided to the fixed position in base frame 21. Accordingly, the above-described configuration allows further simplification of the installation operation.

Furthermore, when tip-up frame 22 is disposed inside base frame 21 in the seat width direction and rotation axis O of tip-up frame 22 is disposed so as to cross paired side frames 21L and 21R of base frame 21 as in vehicle seat 1 according to the present embodiment, the hinge portion cannot be accessed from outside in the seat width direction during installation. However, each of paired supported brackets 22S of tip-up frame 22 fixed to a corresponding one of paired side frames 21L and 21R of base frame 21 is pivotably provided in advance in a corresponding one of paired side frames 22L and 22R of tip-up frame 22 as described above, thereby eliminating the need of access to the hinge portion from outside in the seat width direction during installation. Thus, even when rotation axis O of tip-up frame 22 is disposed at the above-described position for reduction in thickness of cushion frame 20 in the seat up-down direction and the like as in the present embodiment, tip-up frame 22 can be readily installed in base frame 21 so as to be pivotable.

Furthermore, vehicle seat 1 according to the present embodiment has a configuration in which the above-described receiving portion is provided in each of paired supporting brackets 21S while the above-described protruding portion is provided in each of paired supported brackets 22S. Thus, tip-up frame 22 is moved by its self-weight to the fixed position during installation, thereby allowing further simplification of installation.

Furthermore, vehicle seat 1 according to the present embodiment has a configuration in which the above-described bottom portion 21e and engagement hole portion 21e1 are provided in each of paired supporting brackets 21S while the above-described engagement protrusion and contact portion are provided in each of paired supported brackets 22S. Thus, tip-up frame 22 is allowed to be self-standing on base frame 21 while being disposed at the fixed position, thereby allowing further simplification of installation.

Furthermore, vehicle seat 1 according to the present embodiment has a configuration in which paired supporting brackets 21S and paired supported brackets 22S each are formed of a single plate-shaped bracket or a plurality of plate-shaped brackets. Thus, installation of tip-up frame 22 in base frame 21 is simplified while suppressing an increase in weight of the entire vehicle seat 1.

Furthermore, vehicle seat 1 according to the present embodiment has a configuration in which biasing spring 25 is extended under tension between supported bracket 22S and auxiliary bracket 22T in advance. This eliminates the need to separately attach biasing spring 25 after installation of tip-up frame 22 in base frame 21. Thus, vehicle seat 1 can be readily manufactured without requiring a troublesome installation operation.

### 6. Other Embodiments

Specific arrangement positions, shapes, materials, dimensions and the like of various types of members described in the above embodiments are merely by way of example, and therefore, can be modified as appropriate in accordance with the specifications of the vehicle seat to be manufactured. For example, the rotation axis of the tip-up frame does not necessarily have to overlap with the pair of first side wall portions of the base frame, but can be arranged so as not to overlap with the pair of first side wall portions of the base frame, as a matter of course. Furthermore, each of the supporting bracket and the supported bracket does not necessarily have to be formed of a plate-shaped bracket, but can also be formed of a member having a block shape and the like.

Furthermore, the above-described embodiments have been explained with reference to an example of the configuration in which a tip-up frame is installed in a base frame from above during installation of the tip-up frame in the base frame. However, the tip-up frame can also be installed in the base frame from the front side.

In this case, it is preferable that each of the supporting brackets as a pair of supporting portions is configured to have a recessed receiving portion that is opened at its front end in the seat front-rear direction, and that each of the supported brackets as a pair of supported portions is configured to have a protruding portion protruding in the seat width direction. Thereby, it is preferable that the protruding portion is inserted into the receiving portion and guided therein, thereby allowing the tip-up frame to reach the fixed position.

By the configuration as described above, even in the configuration in which the tip-up frame is installed in the base frame from the front side, the pair of supported brackets is guided by the pair of supporting brackets to the fixed position, and also, the tip-up frame can be configured to be self-standing on the base frame white being disposed at the fixed position. This results in simplification of installation of the tip-up frame in the base frame.

Furthermore, the same method also allows a configuration in which the tip-up frame is installed in the base frame diagonally from front, diagonally from behind, and diagonally from above. This allows a configuration in which the paired supported brackets are guided by the respective paired supporting brackets so as to slide down by its self-weight, with the result that the paired supported brackets are guided to the fixed position. Thus, installation of the tip-up frame in the base frame can be significantly simplified. In this way, the tip-up frame may be installed in the base frame in any direction as long as the direction is orthogonal to the seat width direction.

Furthermore, the above-described embodiments have been explained with reference to an example of the case where the present disclosure is applied to a vehicle seat configured as a seat of an automobile, but the present disclosure is also applicable to any kind of vehicle seat such as a seat installed in a ship, an airplane, an electric train, and the like.

The following is a summarized explanation about the above-described details of the present disclosure.

A vehicle seat according to an aspect of the present disclosure includes: a cushion frame formed as a framework of a seat cushion; and a seat back provided at a rear end portion of the seat cushion. The cushion frame includes a base frame, a tip-up frame supported by the base frame so as to be pivotable about a rotation axis extending in a seat width direction, and a biasing member configured to bias the tip-up frame toward the seat back in a direction in which the tip-up frame pivots. The base frame includes a pair of first side wall portions that are located to face each other in the seat width direction, and a pair of supporting portions that are located to face each other in the seat width direction, each of the paired supporting portions being provided in a corresponding one of the paired first side wall portions. The tip-up frame includes a pair of second side wall portions that are located to face each other in the seat width direction, and a pair of supported portions that are located to face each other in the seat width direction, each of the paired supported portions being pivotably connected to a corresponding one of the paired second side wall portions. Each of the paired supported portions is fixed to a corresponding one of the paired first side wall portions while being supported by a corresponding one of the paired supporting portions. Each of the paired supporting portions is capable of guiding a corresponding one of the paired supported portions in a direction orthogonal to the seat width direction to bring the tip-up frame to a fixed position in the base frame, and capable of supporting a corresponding one of the paired supported portions so as to cause the tip-up frame to be self-standing on the base frame in a state where the tip-up frame is disposed at the fixed position and in a state before the paired supported portions are fixed.

By the configuration as described above, installation of the tip-up frame in the base frame is significantly simplified. Specifically, each of the paired supported portions of the tip-up frame to be fixed to a corresponding one of the paired first side wall portions of the base frame is pivotably provided in advance in a corresponding one of the paired second side wall portions of the tip-up frame, so that the tip-up frame can be pivotably installed in the base frame in a simple operation of fixing each of the paired supported portions to a corresponding one of the paired first side wall portions. In this case, by the configuration in which each of the paired supported portions of the tip-up frame is guided to the fixed position by a corresponding one of the paired supporting portions of the base frame during installation of the tip-up frame in the base frame, the tip-up frame can be readily positioned relative to the base frame. Also by the configuration in which the tip-up frame is allowed to be self-standing on the base frame while being disposed at the fixed position, the state after positioning is maintained by the paired supporting portions. Thus, the operation of fixing each of the paired supported portions of the tip-up frame to a corresponding one of the paired first side wall portions of the base frame can also be readily performed.

In the vehicle seat according to an aspect of the above-described present disclosure, the tip-up frame may be disposed inside the base frame in the seat width direction, and the rotation axis may be located to cross the paired first side wall portions.

In this way, in the case where the tip-up frame is disposed inside the base frame in the seat width direction and the rotation axis of the tip-up frame is located to cross the paired first side wall portions of the base frame, the hinge portion cannot be accessed from outside in the seat width direction during installation. However, as described above, each of the paired supported portions of the tip-up frame to be fixed to a corresponding one of the paired first side wall portions of the base frame is pivotably provided in advance in a corresponding one of the paired second side wall portions of the tip-up frame, thereby eliminating the need of access to the hinge portion from outside in the seat width direction during installation. Therefore, even in the case where the rotation axis of the tip-up frame is disposed at the above-described position, for example, for reducing the thickness of the cushion frame in the seat up-down direction, the tip-up frame can be readily installed in the base frame so as to be pivotable.

In the vehicle seat according to an aspect of the above-described present disclosure, it is preferable that each of the paired supporting portions has a receiving portion formed in a recessed shape, the receiving portion being opened at an upper end thereof in a seat up-down direction and formed to become narrow from the upper end to a downward direction. It is also preferable that each of the paired supported portions has a protruding portion protruding in the seat width direction. In this case, it is preferable that, during installation of the tip-up frame in the base frame, the protruding portion is inserted into the receiving portion and guided therein, to cause the tip-up frame to reach the fixed position by a self-weight of the tip-up frame.

By the configuration as described above, the tip-up frame is moved by its self-weight to thereby reach the fixed position during installation, which allows further simplification of installation.

In the vehicle seat according to an aspect of the above-described present disclosure, it is preferable that each of the paired supporting portions has a bottom portion and an engagement hole portion provided in the bottom portion, and also preferable that each of the paired supported portions has an engagement protrusion protruding downward and a contact portion facing downward. In this case, it is preferable that, during installation of the tip-up frame in the base frame, the tip-up frame is disposed at the fixed position, to bring the contact portion into contact with the bottom portion and to cause the engagement protrusion to be inserted into the engagement hole portion, to thereby allow each of the paired supported portions to be supported by a corresponding one of the paired supporting portions, and allow the tip-up frame to be self-standing on the base frame.

By the configuration as described above, the tip-up frame is readily allowed to be self-standing on the base frame while being disposed at the fixed position, thereby allowing further simplification of installation.

In the vehicle seat according to an aspect of the above-described present disclosure, each of the paired supporting portions may have a receiving portion formed in a recessed shape, the receiving portion being opened at a front end thereof in a seat up-down direction, and each of the paired supported portions may have a protruding portion protruding in the seat width direction. In this case, it is preferable that, during installation of the tip-up frame in the base frame, the protruding portion is inserted into the receiving portion and guided therein, to allow the tip-up frame to reach the fixed position.

By the configuration as described above, the tip-up frame can be installed in the base frame from the front side in the seat front-rear direction. Also in this case, as described above, by the configurations in which each of the paired supported portions of the tip-up frame is guided to the fixed position by a corresponding one of the paired supporting portions of the base frame, and in which the tip-up frame is allowed to be self-standing on the base frame while being disposed at the fixed position, installation of the tip-up frame in the base frame is simplified.

In the vehicle seat according to an aspect of the above-described present disclosure, it is preferable that the paired supporting portions and the paired supported portions each are formed of a single plate-shaped bracket or a plurality of plate-shaped brackets.

By the configuration as described above, installation of the tip-up frame in the base frame is simplified while suppressing an increase in weight of the entire vehicle seat.

In the vehicle seat according to an aspect of the above-described present disclosure, it is preferable that the biasing member is extended under tension between at least one of the paired supported portions and at least one of the paired second side wall portions.

By the configuration as described above, the tip-up frame can be installed in the base frame after a biasing member is attached to the tip-up frame in advance, thereby eliminating the need to separately attach a biasing member after installation of the tip-up frame in the base frame. Therefore, a vehicle seat can be more readily manufactured without requiring troublesome operations.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A vehicle seat comprising:
a cushion frame formed as a framework of a seat cushion; and
a seat back provided at a rear end portion of the seat cushion,
the cushion frame including
a base frame,
a tip-up frame supported by the base frame so as to be pivotable about a rotation axis extending in a seat width direction, and
a biasing member configured to bias the tip-up frame toward the seat back in a direction in which the tip-up frame pivots,
the base frame including
a pair of first side wall portions that are located to face each other in the seat width direction, and
a pair of supporting portions that are located to face each other in the seat width direction, each of the paired supporting portions being provided in a corresponding one of the paired first side wall portions,
the tip-up frame including
a pair of second side wall portions that are located to face each other in the seat width direction, and
a pair of supported portions that are located to face each other in the seat width direction, each of the paired supported portions being pivotably connected to a corresponding one of the paired second side wall portions,
each of the paired supported portions is fixed to a corresponding one of the paired first side wall portions while being supported by a corresponding one of the paired supporting portions,
each of the paired supporting portions is
capable of guiding a corresponding one of the paired supported portions in a direction orthogonal to the seat width direction to bring the tip-up frame to a fixed position in the base frame, and
capable of supporting a corresponding one of the paired supported portions so as to cause the tip-up frame to be self-standing on the base frame in a state where the tip-up frame is disposed at the fixed position and in a state before the paired supported portions are fixed.

2. The vehicle seat according to claim 1, wherein
the tip-up frame is disposed inside the base frame in the seat width direction, and
the rotation axis is located to cross the paired first side wall portions.

3. The vehicle seat according to claim 1, wherein
each of the paired supporting portions has a receiving portion formed in a recessed shape, the receiving portion being opened at an upper end thereof in a seat up-down direction and formed to become narrow from the upper end to a downward direction,
each of the paired supported portions has a protruding portion protruding in the seat width direction, and
during installation of the tip-up frame in the base frame, the protruding portion is inserted into the receiving portion and guided therein, to cause the tip-up frame to reach the fixed position by a self-weight of the tip-up frame.

4. The vehicle seat according to claim 1, wherein
each of the paired supporting portions has a bottom portion and an engagement hole portion provided in the bottom portion,
each of the paired supported portions has an engagement protrusion protruding downward and a contact portion facing downward, and
during installation of the tip-up frame in the base frame, the tip-up frame is disposed at the fixed position, to bring the contact portion into contact with the bottom portion and to cause the engagement protrusion to be inserted into the engagement hole portion, to thereby allow each of the paired supported portions to be supported by a corresponding one of the paired supporting portions, and allow the tip-up frame to be self-standing on the base frame.

5. The vehicle seat according to claim 1, wherein
each of the paired supporting portions has a receiving portion formed in a recessed shape, the receiving portion being opened at a front end thereof in a seat up-down direction,
each of the paired supported portions has a protruding portion protruding in the seat width direction, and
during installation of the tip-up frame in the base frame, the protruding portion is inserted into the receiving portion and guided therein, to allow the tip-up frame to reach the fixed position.

6. The vehicle seat according to claim 1, wherein the paired supporting portions and the paired supported portions each are formed of a single plate-shaped bracket or a plurality of plate-shaped brackets.

7. The vehicle seat according to claim 1, wherein the biasing member is extended under tension between at least one of the paired supported portions and at least one of the paired second side wall portions.
